(19) United States
(12) Patent Application Publication
(10) Pub. No.: US 2007/0078957 A1
(43) Pub. Date: Apr. 5, 2007

(54) Firmware-licensing system for binding terminal software to a specific terminal unit

(75) Inventors: Tapio Ypyä, Perttula (FI); Arto Mutanen, Tervakoski (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/211,179

(22) Filed: Aug. 24, 2005

(51) Int. Cl. G06F 15/177

(52) U.S. Cl. 709/222

(57) ABSTRACT

An improved system and method for providing firmware upgrades and similar information to mobile electronic devices while protecting the firmware from impermissible copying and other undesirable activities. The delivery of a firmware upgrade to a terminal is divided into two parts. A firmware upgrade package contains the payload and the real binary content for the firmware reflashing process in the terminal. A license package binds the firmware package to a specific terminal and enables its use. The binding forms a chain of trusted elements: the firmware, a firmware identifier, a license identifier, a hardware identifier, and hardware.

### FIELD OF THE INVENTION

The present invention relates generally to the use of firmware in mobile electronic devices. More particularly, the present invention relates to systems for providing firmware upgrades and similar information to mobile electronic devices while protecting the firmware from impermissible copying and other undesirable activities.

### BACKGROUND OF THE INVENTION

The basic software in a mobile telephone typically comprises an operating system, hardware related device drivers, digital signal processing code, protocol stack implementations and a number of native applications. This software is commonly and collectively referred to as firmware. The manufacturer of such a mobile terminal has a number of potential liabilities that are related to the firmware. For example, the terminal manufacturer must attempt to protect the interests of the copyright owners of the firmware. In the past, secrets such as the underlying code in the firmware were not easily accessible by end-users, as the terminal's specifications and the firmware itself were kept confidential and disclosed only to trusted partners. For example, upgrading the terminal firmware has traditionally only been possible by using special equipment that was not generally available to the public, instead only being provided to authorized service partners.

However, the level of secrecy surrounding firmware is rapidly changing. Terminals are increasingly based upon open platforms, exposing the architecture to a broader audience. Additionally, the firmware is becoming more accessible, as terminal firmware over-the-air (FOTA) updates take place. FOTA enables field upgrades for the terminals. Field upgrades can potentially reduce the related costs, time and effort, and are therefore a very attractive option for the terminal vendors, operators and end-users.

Although useful for the reasons discussed above, terminal platforms and FOTA have increased the need to control the updates and usage of firmware at terminal level granularity. There are business and technical reasons for this. From a business point of view, there is a serious need to prevent firmware forward copying, while also allowing controlled changes of firmware (e.g., supporting operator churns and fulfilling government authority and corporate requirements). There is also a need to have the ability to recall and monitor firmware updates, as well as enabling new business models. For example, there is a need to provide operator-requested additional features for defined terminals in a controlled manner, and to provide chargeable firmware updates. There is also a need to prevent the installation of incompatible update packages in the case of hidden variants, and a need to protect the interests of copyright owners.

From a technical point of view, it must be possible to prevent the usage of the illegally copied images of the firmware. The terminal must have a manufacturer-granted permission to make a certain firmware update. The permission has to be terminal specific. There also needs to be the ability to bypass the firmware update control for a selected firmware update. The rules of the conditional firmware update control have to be based upon an authority domain (e.g. operator or corporate). Lastly, it must be possible to change the authority domain (i.e. the valid policies of firmware update control) of the terminal.

The conventional security concept for firmware has been based upon proprietary terminal architecture. The read-only-memory (ROM), where firmware has been located, has generally not been available for reading or writing. Hidden (undocumented) algorithms have been used for firmware protection, and special hardware-based flashing tools such as prommer equipment have been needed to reflash terminals. The reflashing has only been possible through the use of trusted service point personnel, and the users of the flashing tools have been authenticated by a smart card-based solution.

Currently, terminal reflashing takes place in a trusted and secure environment of a service point, represented at 100 in FIG. 1, and the entire firmware is replaced as one entity. A service point agent acts as a gatekeeper 110 in order to protect the business interests of a terminal manufacturer or operator and other stakeholders. As FOTA evolves, however, when firmware upgrades or updates are downloaded in digital increments directly to an end user's terminal over-the-air or via another connectivity method, a human gatekeeper must be replaced with the system-provided automatic security controls. This is depicted in FIG. 1. Existing terminal security solutions must be enhanced even to maintain the current security level of firmware reflashing. In addition, capitalization of new business opportunities, such as firmware related customer segmentations or upgrade sales, will result in completely new requirements for terminal security and for the supporting infrastructure and processes.

The new open terminal platforms release the control of service point reflashing in order to make firmware updates faster and more flexible. Compared to older terminal generations, the open platforms with FOTA capability do not require any specific repair center hardware in order to permit reflashing; any person can theoretically copy a new firmware version into the terminal memory. Unfortunately, this seriously weakens the commercial control of firmware assets, and the lack of transition control could prevent future advanced business models and service aspects.

In an FOTA arrangement, security must be ensured in order to support both the transition control (i.e., permissions for firmware updates) and the state control (i.e., permissions to use the firmware image). Transition control takes place at the delivery phase, which includes the process steps from discovery of the feasible firmware alternatives to activation of the selected firmware in the mobile terminal. State control refers to the usage phase security of the firmware in the boot-up phase or during the run-time of the device, regardless of how the firmware had appeared in the device.

Both transition control and state control are vital for a number of reasons. Several business scenarios around firmware updates trust the FOTA service's ability to follow and report firmware update transactions in a trustable way at the most dynamic level of granularity—the terminal. This capability allows for the application of business rules at the terminal level, giving wider update permissions for some terminals while restricting the available update alternatives for others. With full transaction control, a manufacturer or other interest group can ensure that it is possible to run the updated firmware only in those particular terminals which have been granted the appropriate firmware update permissions. Additionally, a determined hacker will always find ways to bypass transition security and copy a full firmware image from one device to another. It is therefore especially important to have a mechanism to prevent uncontrolled forward copying of firmware. Also, the possibility to copy the firmware would jeopardize many important business models and service concepts such as chargeable upgrades and firmware based price differentiation between phone models. State control is therefore needed to check the validity of the permission for using the firmware in the device in order to prevent non-authorized copying.

### SUMMARY OF THE INVENTION

The present invention provides for a trustable control and licensing mechanism for firmware updates and similar information. The present invention involves the use of an improved firmware-licensing system that is designed to be effective and secure in an open architecture environment, such as a Symbian environment, where the memory of the terminal is accessible by untrusted parties. The present invention uses public key infrastructure (PKI)-based certificates to bind the allowed firmware image to a specific device or terminal. The binding forms a chain of trusted elements: the firmware, a firmware identifier, a license identifier, a hardware identifier, and hardware. The system and method of the present invention could also be used for other digital products and services, in addition to firmware updates. The present invention addresses both the business and technical requirements discussed above for protecting firmware in open architecture terminals.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction showing the evolution of FOTA arrangements for mobile electronic devices;

FIG. 2 is a perspective view of a mobile telephone that can be used in the implementation of the present invention;

FIG. 3 is a schematic representation of the telephone circuitry of the mobile telephone of FIG. 2;

FIG. 4 is a depiction of the implementation of PKI-based FOTA control in accordance with one embodiment of the present invention;

FIG. 5 is an illustration of enhanced firmware state control according to the principles of the present invention;

FIG. 6 is an illustration of FOTA transition control with firmware certificates and hardware certificates;

FIG. 7 is an illustration of an architecture that enables an uncontrolled delivery of a firmware update;

FIG. 8 is a depiction showing an example of the authority domains used with firmware licenses;

FIG. 9 is a depiction of a process showing the retrieval of a firmware license directly from a manufacturer using an online connection;

FIG. 10 is a depiction of a process showing the retrieval of a firmware license in an online connection through an operator;

FIG. 11 is a depiction of a process showing the creation of firmware licenses as an offline batch job; and

FIG. 12 is a depiction of a process showing the generation of a firmware license by an operator according to one embodiment of the present invention.

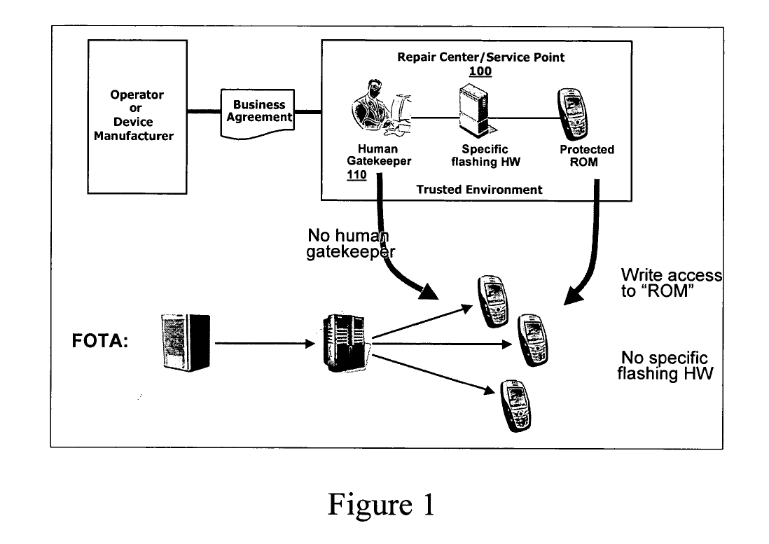

### DETAILED DESCRIPTION OF THE PREFERRED EMBODIMENTS

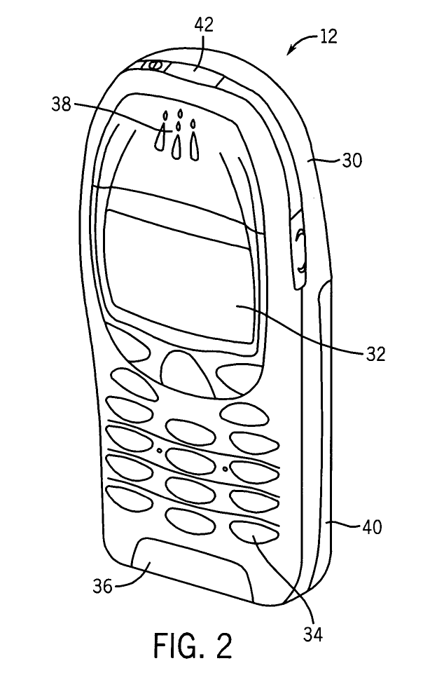

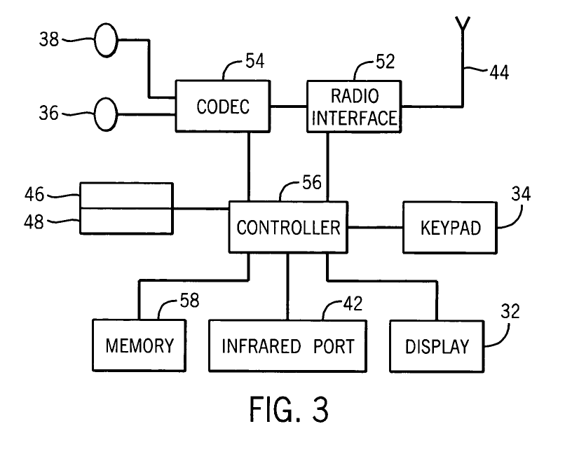

FIGS. 2 and 3 show one representative mobile telephone 12 for which the present invention may be implemented. This mobile telephone 12 can serve as a client terminal or a server depending upon the particular system at issue. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, code circuitry 54, a controller 56 and a memory 58. Individual circuits and elements are all of a type well known in the art, for example in the Nokia range of mobile telephones.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

According to the present invention, the delivery of a firmware upgrade to a terminal is divided into two parts. First, a firmware upgrade package contains the payload and the real binary content for the firmware reflashing process in the terminal. The package, as such, is valid for any technically compatible terminal and can be delivered through several channels by any actor in the business value network. The delivery process can be kept efficient and flexible by utilizing caching mechanisms, multi-channel distribution or scheduled over the air (OTA) delivery during low-load periods of a mobile operator's cellular network. The reflashing operation of the firmware upgrade package is not possible in a terminal without a related license package.

Second, a license package binds the firmware package to a specific terminal and enables its use. A manufacturer delivers the license packages to terminals in an online session. During the creation of the package, the system validates the delivered firmware package (i.e., checks the applicability, origin and permissibility of the firmware upgrade). The rights object package is valid for one terminal only; it cannot be used in other terminals, but each terminal has to fetch its own license package to enable the activation of the firmware package.

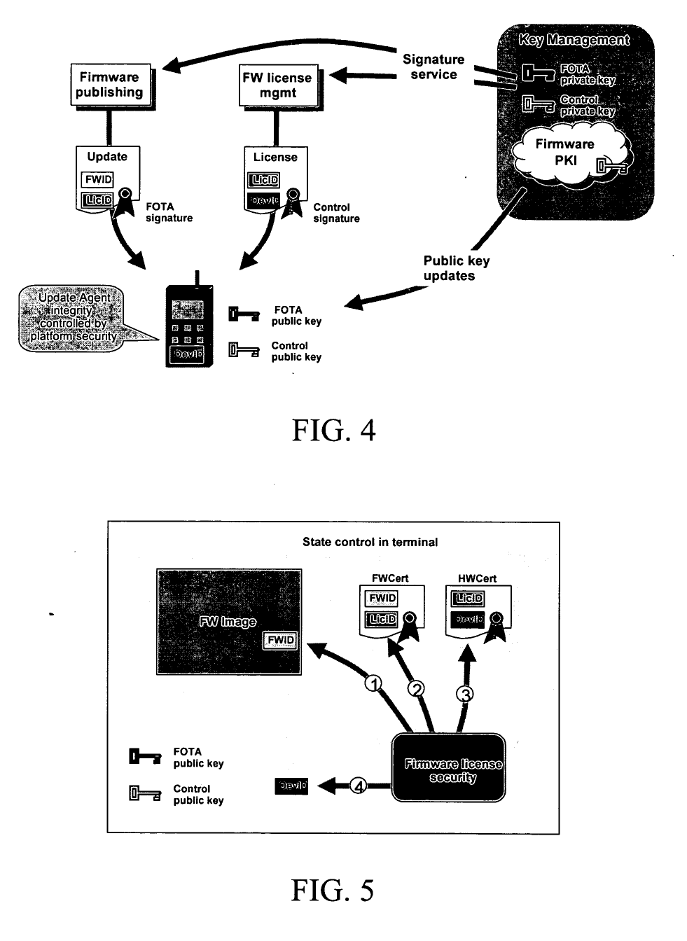

FIG. 4 is a depiction of the implementation of PKI-based FOTA control in accordance with one embodiment of the present invention. In this implementation, it is not possible to use a license package in a device other than the device to which the license has been granted. This is referred to as device binding. Additionally, the PKI private key is stored in a manufacturer server system or in another trusted environment instead of within the terminal.

In one embodiment of the invention, the firmware publishing process produces a firmware update package. The update package includes a firmware version identifier (FWID) of the new firmware and the identifier of the license (LicID). The license is needed to enable the firmware update. The update package is signed with a manufacturer FOTA signature. The signature is created using the manufacturer's FOTA private key.

A terminal requests a firmware license from the manufacturer FOTA service. The service creates the firmware license package, including the identifier of the license, and trustable identifier of the device. There is a control signature over the whole package in the firmware license.

Before the activation of the firmware update package, the update agent in the terminal checks the integrity of both packages by using related public keys. Basic terminal platform security finctionality then verifies the validity of the public keys. The update agent checks that the device identifier in the firmware license matches the identifier in the terminal and verifies that the LicID in both packages is the same. The integrity of the update agent itself, as well as the device identifier in the device, has to be validated by the terminal platform security functionality.

FWID and LicID parameters of the update package are carried inside a firmware certificate (FWCert). In the update process, the terminal stores the firmware certificate into the terminal as a separate entity. In a similar manner, the license is stored as a hardware certificate (HWCert).

FIG. 5 is an illustration of enhanced firmware state control according to the principles of the present invention. Without the license based firmware state control there is no support for chargeable firmware upgrades, firmware based differentiation or any type of device level control of firmware updates. Without the control mechanism booting the device with firmware copied from another terminal is possible as long as the firmware originated from the manufacturer and not tampered.

Sufficient commercial control requires that any firmware release can be bound to the terminal at any point of time during the terminal's lifecycle, and that this binding is checked during the boot process or in run-time.

As depicted in FIG. 5, the firmware license security checks the existence of the firmware certificate and the hardware certificate. In one embodiment of the invention, the validity checking occurs as follows. First, the validity of the firmware image is checked, and the firmware identifier or equivalent identification information of the controlled software entity is read and validated. This is followed by the signature in the firmware certificate being checked. The FWID in the firmware image is compared to the FWID in the firmware certificate, and the needed LicID is read from the firmware certificate. The validity of the signature is then checked in the hardware certificate, and the LicID in the FWCert is compared to the LicID in the HWCert. The device identifier is read from the HWCert. Lastly, the device identifier (DevID) from the HWCert is compared to the DevID in the device.

In certain situations, there may be a need to deliver some firmware versions or version updates without transition control, i.e. without using the firmware update license. The reason for using such a free delivery mode may emerge from business agreements between the terminal manufacturer and an operator, or simply from enabling a quick and efficient delivery of packages such as important bug fix packages.

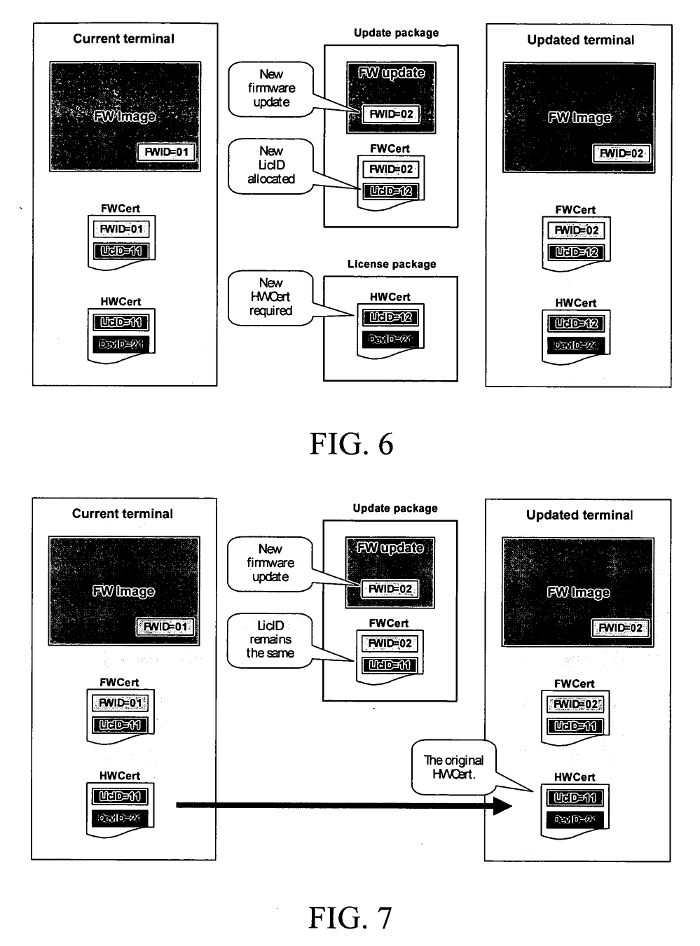

By selecting a new LicID for the firmware update (and the related FWCert), the transition control is activated. When the firmware update agent in the terminal receives an update package and the attached FWCert, it recognizes that the LicID does not match with the LicID in the existing HWCert and starts the firmware license retrieval. FIG. 6 illustrates an example where transition control is required.

FIG. 7 is an illustration of an architecture that enables an uncontrolled delivery of a certain firmware update (but not an uncontrolled usage of the resulting firmware image). The LicID is defined to remain the same for the new firmware. The update agent can realize that the original HWCert is still valid, and there is no need to fetch a new one. In this situation, firmware reflashing can begin immediately after update package delivery without downloading a license package. It should be noticed that, even when skipping the transition control, the state control still remains; there is a valid HWCert in place for the next boot-up phase when firmware license security checks are activated.

The rules for using transition control, i.e. the selections of LicIDs, are defined by a firmware authority. The firmware authority can comprise, for example, an operator or a corporate entity. The pool of terminals under one firmware authority forms an authority domain. The license handling in a firmware update transaction is therefore specific to an authority domain. The LicID is authority domain-specific. One firmware can belong to many authority domains. Inside an authority domain, firmware has a unique LicID.

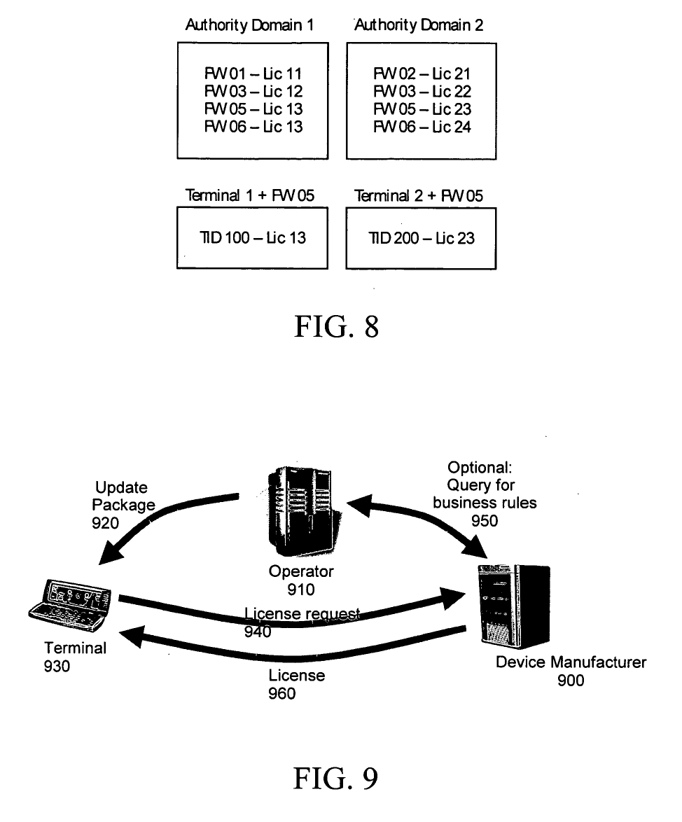

As shown in the example in FIG. 7, the same firmware (e.g., FW 05) can belong to many different authority domains (e.g., AD1 and AD2). For each authority domain, however, the firmware has an authority specific LicID (e.g., LicID 13 in AD1 and LicID 23 in AD2). In this example, firmware authority 1 has decided not to use transition control for updating FW05 to FW06; terminal 1 can download FW06 or a related update package without having to renew the hardware certificate. The same firmware update for terminal 2, belonging to authority domain 2, means that the LicID has changed to LicID 24 in FIG. 8. The terminal must obtain a new HWCert with the updated LicID-TID binding in order to be able to apply the update and run the new firmware version. As is shown in FIG. 8, changing a terminal from one authority domain to another always requires transition control.

There are several options for delivering a firmware license to a terminal. In one embodiment, the license can be retrieved directly from the device manufacturer in an online device session. However, there can be relationship-related, commercially-related (mobile transmission costs for the end user) and technical (mobile network configurations, availability, load balancing) reasons to use other methods of delivery. Some delivery options are as follows.

Online connection to device manufacturer. In a direct manufacturer delivery system, depicted in FIG. 9, an operator 910 or a device manufacturer 900 delivers the firmware update package, represented at 920. The terminal 930 identifies the need for a firmware license and contacts the device manufacturer's firmware license system at step 940. The system validates the terminal according to the parameters in the request and the information in the back-end systems. Optionally, the device manufacturer's license system may query the acknowledgement from the operator 910 at step 950. Finally, the terminal receives the license from the device manufacturer's license system at step 960 and continues with the update process.

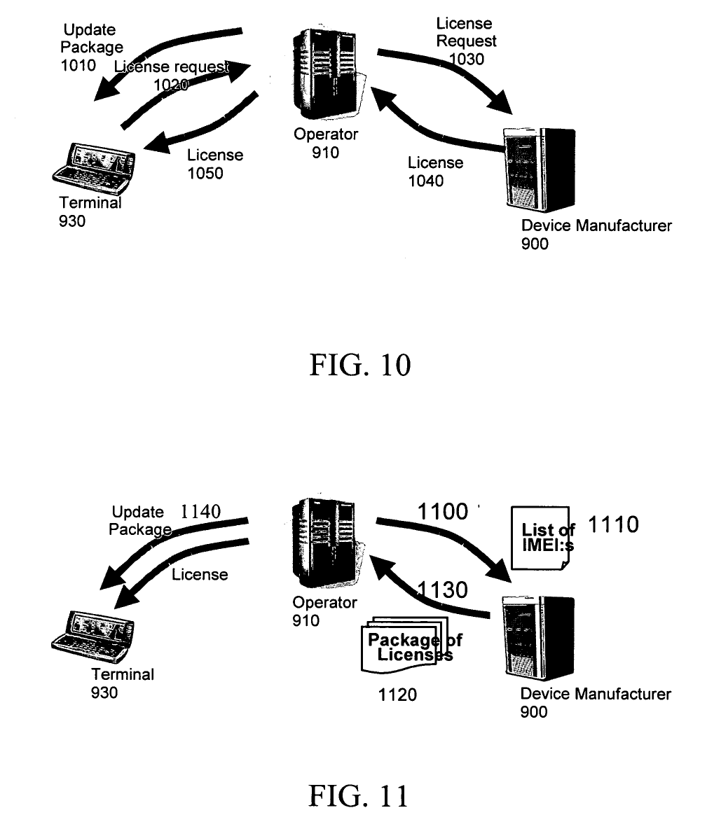

Online connection via an operator. In this arrangement, and as depicted in FIG. 10, the operator 910 or the device manufacturer 900 delivers the firmware update package at step 1010. The terminal 930 identifies the need for a firmware license and contacts the operator FOTA system to obtain the license at step 1020. The operator's FOTA system forwards the license request to the device manufacturer's firmware license system with the selected set of parameters at step 1030. The device manufacturer's system validates the request and, if the validation is successful, creates the firmware license and transmits it back to the operator's FOTA system at step 1040. The FOTA system then delivers the license to the terminal 930 at step 1050.

Offline delivery via an operator. In the embodiment depicted in FIG. 11, the operator 910 prepares a massive FOTA operation and transmits a list of IMEIs 1100 to the device manufacturer 900 at step 1100. The device manufacturer 900 creates the corresponding license packages 1120 and sends them back to the operator 910 at step 1130. The operator's FOTA system will later deliver both firmware update package and firmware license package in one transaction to the terminal at step 1140.

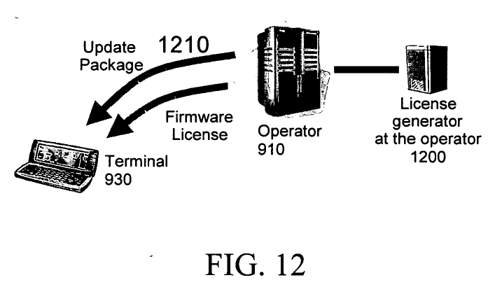

Licenses generated by an operator. In this embodiment, and as depicted in FIG. 12, an operator 910 is provided with a firmware license generator 1200. The license system is hosted in the operator's environment. The operator can create firmware licenses in real time, according to the requests from the terminals. Alternatively, the operator can create licenses beforehand as a batch job and deliver the licenses together with firmware update packages to the terminal 930 at step 1210.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques, with rule based logic, and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of installing firmware-related content on an electronic device in a secure manner, comprising:
receiving a firmware package from outside of the electronic device;
receiving a license package from outside of the electronic device, the license package including a device identifier;
determining whether the device identifier corresponds to the electronic device; and
if the device identifier corresponds to the electronic device, enabling the activation of the firmware package within the electronic device using the license package.

2. The method of claim 1, wherein the determining of whether the device identifier corresponds to the electronic device comprises comparing the device identifier in the license package to a device identifier within the electronic device.

3. The method of claim 1, wherein the firmware package comprises a firmware identifier and a license identifier, the license package includes a license identifier and a device identifier, and wherein the activation of the firmware package is not enabled unless the license identifier of the license package matches the license identifier of the firmware package.

4. The method of claim 1, wherein the license package is received directly from a manufacturer of the electronic device.

5. The method of claim 1, wherein the license package is received directly from a service operator for the electronic device.

6. The method of claim 1, wherein the firmware package comprises a firmware update.

7. A computer program product for installing firmware-related content on an electronic device in a secure manner, comprising:
computer code for receiving a firmware package from outside of the electronic device;
computer code for receiving a license package from outside of the electronic device, the license package including a device identifier;
computer code for determining whether the device identifier corresponds to the electronic device; and
computer code for, if the device identifier corresponds to the electronic device, enabling the activation of the firmware package within the electronic device using the license package.

8. The computer program product of claim 7, wherein the determining of whether the device identifier corresponds to the electronic device comprises comparing the device identifier in the license package to a device identifier within the electronic device.

9. The computer program product of claim 7, wherein the firmware package comprises a firmware identifier and a license identifier, the license package includes a license identifier and a device identifier, and wherein the activation of the firmware package is not enabled unless the license identifier of the license package matches the license identifier of the firmware package.

10. The computer program product of claim 7, wherein the firmware package comprises a firmware update.

11. An electronic device, comprising:
a processor; and
a memory unit operatively connected to the processor and including:
computer code for receiving a firmware package from outside of the electronic device;
computer code for receiving a license package from outside of the electronic device, the license package including a device identifier;
determining whether the device identifier corresponds to the electronic device; and
computer code for, if the device identifier corresponds to the electronic device, enabling the activation of the firmware package within the electronic device using the license package.

12. The electronic device of claim 11, wherein the determining of whether the device identifier corresponds to the electronic device comprises comparing the device identifier in the license package to a device identifier within the electronic device.

13. The electronic device of claim 11, wherein the firmware package comprises a firmware identifier and a license identifier, the license package includes a license identifier and a device identifier, and wherein the activation of the firmware package is not enabled unless the license identifier of the license package matches the license identifier of the firmware package.

14. The electronic device of claim 11, wherein the license package is received directly from a manufacturer of the electronic device.

15. The electronic device of claim 11, wherein the license package is received directly from a service operator for the electronic device.

16. The electronic device of claim 11, wherein the firmware package comprises a firmware update.

17. A method of providing firmware-related content to an electronic device in a secure manner, comprising:
transmitting a firmware package to the electronic device;
transmitting a license package to the electronic device, the license package including a device identifier,
wherein the electronic device is not permitted to enable the activation of the firmware package unless the device identifier corresponds to the electronic device.

18. The method of claim 17, wherein the determining of whether device identifier corresponds to the electronic device comprises comparing the device identifier in the license package to a device identifier within the electronic device.

19. The method of claim 17, wherein the firmware package comprises a firmware identifier and a license identifier, the license package includes a license identifier and a device identifier, and wherein the activation of the firmware package is not enabled unless the license identifier of the license package matches the license identifier of the firmware package.

20. A method of providing firmware-related content to an electronic device in a secure manner, comprising:
transmitting a firmware package to the electronic device, and
computer code for transmitting a license package to the electronic device, the license package including a device identifier,
wherein the electronic device is not permitted to enable the activation of the firmware package unless the device identifier corresponds to the electronic device.
